(19) United States
(12) Patent Application Publication
(10) Pub. No.: US 2010/0198757 A1
(43) Pub. Date: Aug. 5, 2010

(54) PERFORMANCE OF A SOCIAL NETWORK

(75) Inventors: Lili Cheng, Bellevue, WA (US); Scott J. Counts, Seattle, WA (US); Danyel Aharon Fisher, Seattle, WA (US); Michael Anthony Affronti, Seattle, WA (US); Marc A. Smith, Belmont, CA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/364,051

(22) Filed: Feb. 2, 2009

(51) Int. Cl. G06F 15/18; G06N 7/02; G06F 15/173

(52) U.S. Cl. 706/12; 706/52; 709/224

(57) ABSTRACT

Providing for characterizing and determining effectiveness of social networks is described herein. By way of example, data descriptive of inter-relationships of persons can be employed to generate a social connectivity map for users of a communication network. Data disseminated or consumed via the communication network can be monitored and characterized in conjunction with task performance. The characterization can be compared with a performance benchmark to rate a composition of a social network, or underlying network applications and functions, in effecting user tasks or other user activities. Accordingly, individuals and organizations can determine and compare the effectiveness of a network in assisting user activities based on predetermined benchmarks, which can be tuned to various aspects, functions or applications of an underlying social network.

### BACKGROUND

Integrated network communications have provided significant advances in social and enterprise activities. On the enterprise side, efficiencies with which individuals can share information, perform tasks, disseminate instructions, search for knowledge-based resources, expose data to users, or share user concerns have greatly increased by advantages provided by inter-personal networks. In regard to social networks, user inter-connectivity and inter-relatedness have been increased as social networking websites, such as Facebook.com, Twitter.com, LinkedIn.com, and so on, have enabled users to share personal information, media files, media applications, pictures, videos, audio, and so on, over the Internet.

In addition to the foregoing, e-mail and other electronic messaging systems have enabled a technical revolution in business and personal communications, and have provided a platform for integrated social and organizational networking. In recent years, use of electronic messaging, such as e-mail, short messaging, text messaging, blogging, electronic forums, and so on, has increased exponentially due to the inexpensive and near instantaneous communication platform that electronic messaging provides. Such platforms have rapidly decreased the time required to share and disseminate information, whether for a large, multi-national organization, a network of friends or family members, or remotely located small business partners.

Building upon the powerful infrastructure of electronic network communications, electronic social networks provide an enhanced ability for individuals to interact and share information utilizing such infrastructure. Additionally, electronic social networks can be implemented in small, private networks, large corporate networks, as well as publicly on the Internet. Users of such networks can perform various communication tasks, such as planning social events, inviting friends to parties, preparing a business meeting, comparing shared investment strategies, and the like. As interactivity and flexibility of social networks continue to increase, the possibilities of applications springing forth from such advancements may open new horizons and break new paradigms in inter-personal and enterprise communications and activities.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

The subject disclosure provides for characterizing and determining effectiveness of social networks. Data descriptive of inter-relationships of persons can be employed to generate a social connectivity map for users of a communication network. Data disseminated or consumed via the communication network can be monitored and characterized in conjunction with task performance. The characterization can be compared with a performance benchmark to rate a social network of individuals, or the communication network, in effecting user tasks or other user activities. Accordingly, individuals and organizations can determine and compare the effectiveness of a network in assisting user activities with various predetermined benchmarks.

According to some aspects of the subject disclosure, optimizing a communication network or digital representation of a social network (e.g., an inter-personal connectivity map managed in an electronic database) can be accomplished. Disparities between a performance benchmark and a network under test can be determined and used to identify deficiencies in the network. In some such aspects, recommendations can be output to a user of the network, highlighting changes to network composition to overcome the deficiencies. According to still other aspects, optimization can be analyzed against a set of performance benchmarks to identify impact of proposed changes on other activities, functions or aspects of the network that might be affected by recommended changes. The analysis can also be output to the user to give a comprehensive effect that the changes might have on the network.

According to one or more additional aspects, the subject disclosure provides for importable/exportable performance benchmarks for rating social networks, or for rating communication networks that provide an electronic interface for members of the social networks. Performance benchmarks can be written as exportable files that can be shared among user communication devices (e.g., computers, laptops, mobile phones, etc.). Such other devices can import the exported files in order to load a benchmark into a particular system or network. Additionally, the benchmarks can be trained or customized to needs of a particular individual, group or enterprise. Thus, as one example, a company could generate a benchmark as a particular standard for its networks, and export the benchmark file for other divisions of the organization to standardize their networks against. Accordingly, network performance benchmarks can be programmable, enabling extensibility and resulting in a dynamic ecosystem for rating or standardizing social and communication networks.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 depicts a block diagram of an example system that provides a performance rating for social networks according to aspects of the subject disclosure.

FIG. 2 illustrates a block diagram of a sample system for characterizing performance of a social network in assisting user activity according to further aspects.

FIG. 3 depicts a block diagram of an example system for representing inter-personal relatedness as an electronic social network according to some aspects.

FIG. 4 illustrates a block diagram of an example system that employs importable benchmark files for rating aspects of a social network.

FIG. 5 depicts a block diagram of an example system that aggregates and characterizes social networks maintained among multiple network platforms.

FIG. 6 depicts a block diagram of a sample system that facilitates optimization of social network composition according to particular disclosed aspects.

FIG. 7 illustrates a flowchart of an example methodology for rating performance of social networks according to other aspects of the subject disclosure.

FIGS. 8 and 9 depict flowcharts of an example methodology for characterizing, rating and optimizing a social network according to some aspects.

FIG. 10 illustrates a block diagram of a suitable operating environment for implementing various aspects of the subject disclosure.

FIG. 11 depicts a block diagram of a sample remote communication environment providing data exchange between remote server and client devices.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, “interface”, “engine”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component can be localized on one computer and/or distributed between two or more computers. As another example, an interface can include I/O components as well as associated processor, application, and/or API components, and can be as simple as a command line or a more complex Integrated Development Environment (IDE).

Communication networks have become powerful tools for sharing knowledge and experience in social settings as well as business settings. Currently, such networks can provide real-time dissemination of information, at almost any distance around the globe. Networks can be public, like the Internet and World Wide Web, or private, such as personal or business networks requiring authorized access to a limited subset of users. Furthermore, communication networks can employ wireless device access or fixed-line device access, or both. Additionally, sub-networks can exist within a larger network, such as a domain or sub-domain, having particular applications and application features, settings or preferences local to the sub-network. Accordingly, by selectively configuring a sub-network, distinctiveness is achieved, both in displaying information to a user, providing access to the user and in facilitating user control over various user-oriented applications.

Recent applications for communication networks include electronically characterizing human groups and organizations and providing a means of electronic communication between members thereof. Human interactions and relationships, termed social networks, include families, groups of friends, business and investment partners, instant message ‘buddies’, members of for profit and non-profit organizations, and the like. In one characterization of inter-personal relationships, individual persons are represented as nodes of a network, and ties between the nodes are based on various interactions and communications between the persons. Each person, or node, is directly connected to others whom the person has direct interaction with. Such person is indirectly connected with other persons, whom their direct contacts have direct interaction with, and still other persons who their direct contacts have indirect interaction with (through one or more other persons), and so on. Thus, in such a characterization of inter-personal relationships, a social network is analogous to a large web of interconnected person-nodes.

By storing node and connectivity data electronically, for instance in a database that tracks individual persons and their direct and indirect relationships, an underlying web of inter-personal relationships can generate an electronic social network. Some electronic social networks are maintained on Internet web sites, including sites such as Facebook®, Twitter™, LinkedIn.com®, or the like. In addition, many corporations include electronic social networks maintained on private intranets, and some private individuals and businesses also maintain electronic social networks on various public and private networks. Electronic social networks that enable individuals to post or share data and media (e.g., photographs, videos, audio recordings, text, blogs, and the like) pertaining to their personal or business interests, hobbies, areas of expertise, research, political views, business ventures, investment portfolios or interests, and so on. In addition, an underlying communication network (e.g., Internet, intranet, mobile communication network, private network) supporting an electronic social network can facilitate electronic communication and data exchange between user nodes of such a social network, in the form of instant message (IM), short message service (SMS), e-mail, voice communication (e.g., voice over Internet Protocol [VoIP], or circuit-switched voice), or other forms of electronic communication. To interact with other network users or with network components supporting the social network, a communication device, such as a computer, mobile phone, laptop, personal digital assistant (PDA), or like electronic device is employed by a network user. Thus, the electronic device provides an interface to the electronic social network and consequently with other network users.

One use for electronic social networks in enterprise is to connect individuals having various experience and expertise on projects and tasks of the organization. Thus, employees can identify individuals having experience in a particular field or on a particular task. Data can be exchanged between such users to effect or guide performance of the task. In addition, enterprise management can disseminate instructions throughout an enterprise, or to selected divisions, workgroups or members thereof, via the electronic social network. Moreover, users can spread information virally, from user to user, employing e-mail, IM or other mass electronic communication mechanisms. The electronic social network therefore can serve as a useful tool in conducting enterprise activities and accomplishing tasks, by disseminating instructions or coupling users of the enterprise.

Although significant benefit can be achieved through electronic social networks, optimizing those benefits can be tedious and time consuming. For instance, network administrators might have to manually collect feedback from users of the network to determine how much assistance the network provides for user tasks, and how efficient that assistance is. Furthermore, identifying changes in the network to optimize one set of interactions can affect, sometimes adversely, other sets of interactions between various users. The larger the electronic social network, the more difficult manual optimization can become, and the more likely that optimizing one aspect of the network detracts from another aspect. Accordingly, a comprehensive mechanism for rating performance of a network and optimizing composition of or infrastructure supporting the electronic social network can provide significant accuracy and efficiency in such optimizations.

To address these or like problems, the subject disclosure provides for rating performance of an electronic social network. In some aspects, dissemination or consumption of data can be analyzed to determine how network infrastructure supporting an electronic social network performs. Additionally, the dissemination or consumption of data can be analyzed to infer user habits, preferences or predispositions toward network applications, network interface devices, select tasks or sets of tasks, or other users of the network. Success of the network can be characterized by monitoring user tasks, activities, feedback and communications, and comparing results of such tasks, activities, etc., with a performance benchmark. The comparison can be quantified or qualified as a function of the dissemination or consumption of data, as a standard for the electronic social network. Based on such comparisons, a performance rating can be given for the electronic social network or supporting infrastructure, as a means of grading the network based on the performance benchmark.

In additional aspects of the subject disclosure, analysis of task performance and data dissemination/consumption can be utilized to optimize composition of the network. Latencies in dissemination or consumption of data can be identified and referenced against a performance benchmark to identify bottlenecks. Such bottlenecks can be characterized by rates at which users consume information provided by others, respond with information, complete tasks, and the like. Furthermore, the rates can be referenced as a function of network user, user interface device, interface or communication application, network group, division or team, network infrastructure involved in transferring information among users, time of day, day of week, period of a year, and so on. A bottleneck can be identified where data dissemination or consumption rates fall below benchmark levels, or levels at which like users or groups of users perform. Thus, characterization of network performance can comprise a comprehensive map of what data is disseminated over the network and when, how well it is disseminated, how users act upon the data, results of such actions, or combinations thereof.

Upon identifying bottlenecks in sharing or consuming data, or in task performance, recommendations can be made to improve the electronic social network. In some aspects, the recommendations could comprise altering composition of the network (e.g., reorganizing user nodes), recommending particular tasks for particular users, recommending other users having a particular expertise for a particular task, recommending changes in infrastructure (e.g., a low bandwidth router or server) to speed dissemination of data, or the like. The recommendations can also be made based on benchmark electronic social network compositions, compared with composition of a network under test. Thus, in addition to rating performance of an electronic social network, improving such a network to more efficiently support user activity is also disclosed.

To increase flexibility and usefulness of the foregoing, also disclosed are exportable/importable performance benchmarks that can be shared among networks or among individuals and organizations. A default benchmark can be trained on a default network comprising a default set of users. The benchmark can be written as an exportable file, and imported to another network, or to another division of the network. Thus, for instance, one division of an enterprise operating in a first country can be utilized to generate a social network benchmark, and another division operating in a second country can be analyzed with respect to the benchmark. Thus, the enterprise can employ the exportable benchmark to compare or standardize operations across disparate networks, even in remote locations. According to at least some aspects, exportable benchmarks can be sold, leased, etc., to other organizations or individuals as standards for an electronic social network. Thus, a new network could be optimized and brought to speed with an existing network, reducing time required to tune a network to needs of an organization.

It should be appreciated that, as described herein, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). The aforementioned carrier wave, in conjunction with transmission or reception hardware and/or software, can also provide control of a computer to implement the disclosed subject matter. Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the amended claims, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

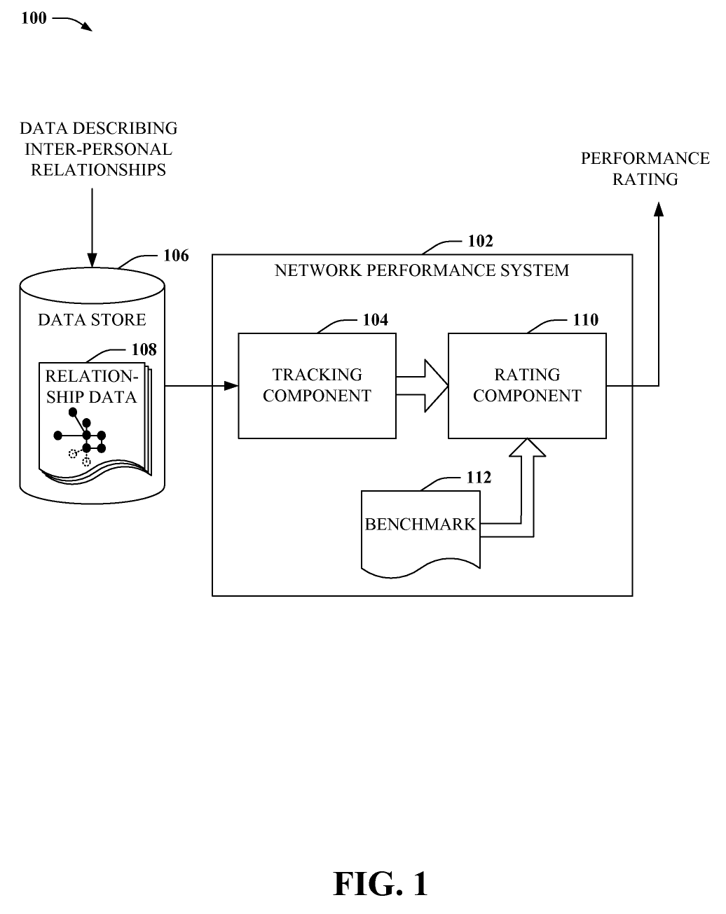

Turning now to the figures, FIG. 1 depicts a block diagram of an example system 100 that can rate performance of an electronic social network according to aspects of the subject disclosure. System 100 can comprise a network performance system 102 that obtains data descriptive of inter-personal relationships of a set of individuals. Such data can be obtained at a data store 106 and stored in a relationship data file 108. In some aspects, data store 106 can comprise long-term or permanent storage, such as a disc or disk drive, hard drive, database, data storage server, or the like. In other aspects, the data store 106 can be temporary data storage, such as random access memory (RAM), Flash memory, cache memory, or the like.

According to some aspects of the disclosure, the relationship data file 108 stores the inter-personal relationships as a web of user nodes, connected by various direct and indirect interactions with other user nodes. The interactions can comprise direct personal communications (e.g., face-to-face communication, electronic communication, voice communication, etc.) as well as indirect communications (e.g., information posted on a website, blog, or the like, that is downloaded or shared with another). The data an be collected by electronic means, such as a search engine, data mining component or the like, or by user input, such as database entry, file upload, text entry, voice entry (e.g., converted to text via speech-to-text processors employing language processing), and so on. Additionally, the data (108) can comprise annotated information, metadata, or other suitable information tags, providing user-node identity or pseudo-identity (e.g., chat room or e-mail handle), expertise, interests, hobbies, experiences of such user-nodes, as well as the type, or quality of the inter-node interactions (e.g., whether electronic communication, face-to-face communication, chat buddies, group-plan cell phone users), or the content or context thereof (e.g., topic of discussion, expertise or experience shared, transcript of communication, etc.).

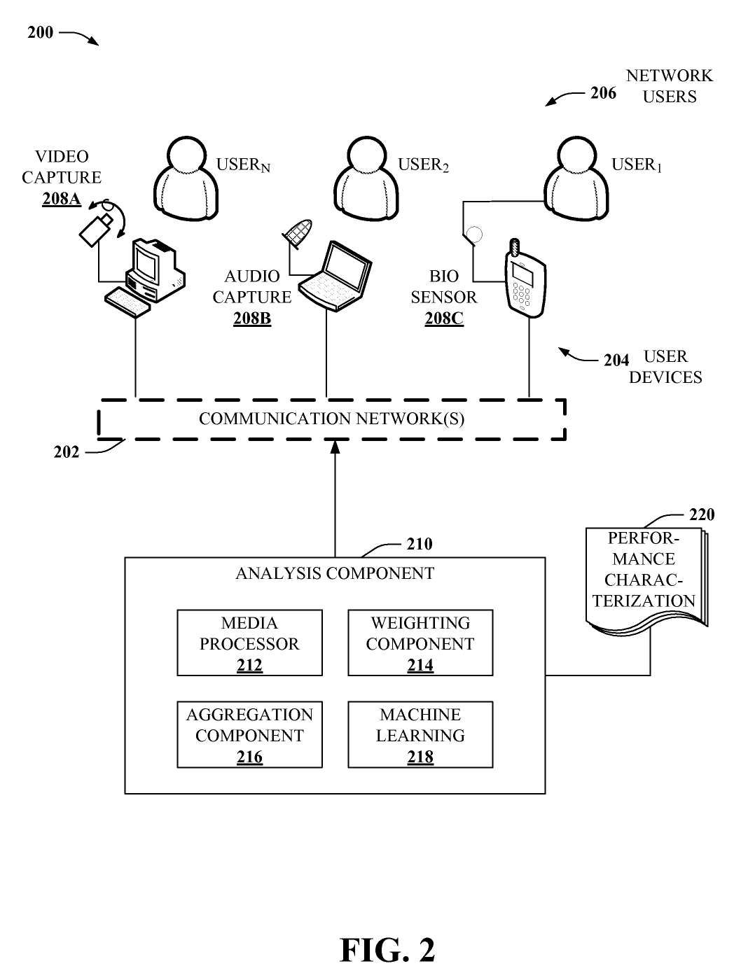

The relationship data file 108, describing the inter-personal relationships of the set of individuals, is provided to the network performance system 102 from data store 106. Network performance system 102 can comprise a tracking component 104 that processes data transmitted over a communication network (not depicted, but see FIGS. 2, 3 and 5, infra). The processed data pertains to information disseminated over an electronic social network associated with the inter-personal relationship data included in the relationship data file 108. In some aspects, the communication network is communicatively coupled with the electronic social network, which is comprised of a subset of the inter-personal relationship. In other aspects, the communication network includes infrastructure that supports (e.g., server, data store, database, query engine, search engine, etc.) the electronic social network. According to particular aspects of the subject disclosure, tracking component 104 monitors dissemination or consumption of data by user devices (not depicted, but see FIGS. 2, 3 and 5, infra) coupled with the communication network. For instance, the tracking component 104 can analyze data compiled, transmitted or received at user communication applications on such user devices. The applications can include an SMS, IM, e-mail, text message, website, blog, really simple syndication (RSS), voice-to-text, media capture, or electronic sensor application providing a user communication/data interface to the communication network. Additionally, tracking component 104 can monitor network infrastructure (e.g., servers, routers, databases, query engines) facilitating data transfer between the user devices. Accordingly, a comprehensive analysis of the dissemination and consumption of data via the communication network can be achieved by tracking component 104.

The dissemination/consumption of data measured by tracking component 104, along with the relationship data (108) can be provided to a rating component 110. Rating component employs the data consumption/dissemination to characterize performance of an electronic social network represented by the relationship data (108). The characterization can be compared with a performance benchmark 112, which includes benchmark statistics for dissemination or consumption of data on a benchmark electronic social network. Based on the comparison, rating component 110 can generate and generate a performance rating for the electronic social network represented by the relationship data (108). Accordingly, network performance system 102 can rate the effectiveness in which the electronic social network assists users in obtaining and sharing data with other users of the network.

FIG. 2 depicts a block diagram of an example system 200 that facilitates characterization of network-related or device-related user activities and effectiveness of an electronic social network (202) in assisting with those activities. Various user-network interface devices can capture information pertinent to the user activities, which can be analyzed to establish a baseline characterization of user activity performance. The activity performance can be cross-referenced against data dissemination, data consumption or like analysis for the electronic social network (202). The baseline characterization, data analysis and results of the comparison can be output to characterize an impact of the electronic social network on user activity.

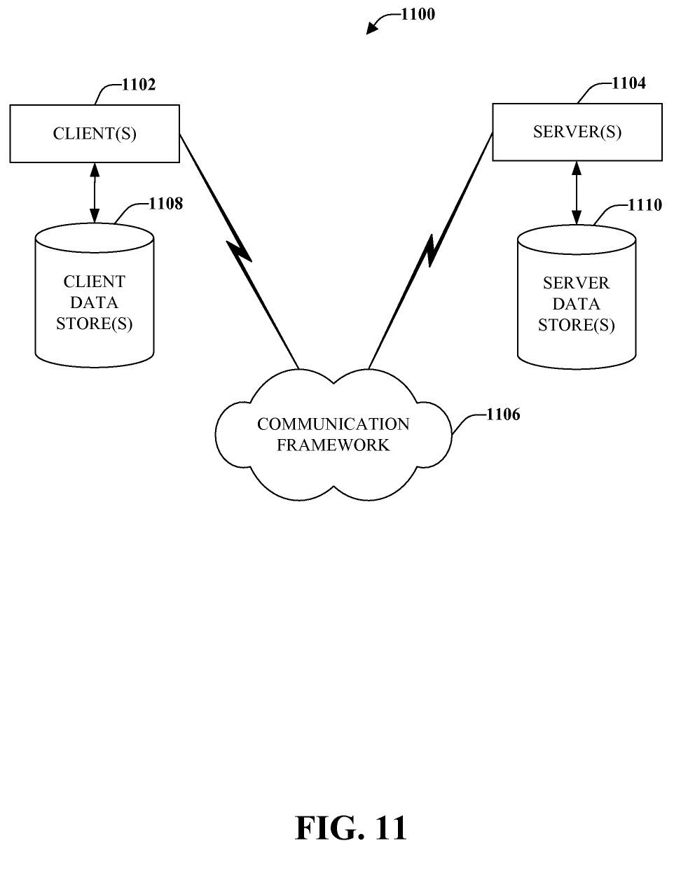

System 200 comprises one or more communication networks 202 facilitating electronic interaction between one or more users 206 of the network, employing one or more user devices 204 as a user-network interface. The communication network(s) 202 can comprise various suitable platforms for remote communication between electronic devices (e.g., see FIG. 11, infra), including fixed line communication networks (e.g., cable line, digital subscriber line [DSL], broadband over power line, Ethernet, or like wired communication interfaces comprising a suitable inter-communication protocol such as transport control protocol/Internet Protocol [TCP/IP] or the like), wireless communication networks (e.g., wireless local area networks [WLANs] such as 802.11a, b, c, d, e, g, h, n, . . . , etc. protocol networks, wireless wide area networks [WWANs], licensed cellular networks, wireless interoperability for microwave access [WiMAX] networks, and so on), or a suitable combination thereof. Additionally, communication network(s) 202 can include, or be directly or indirectly coupled with, infrastructure supporting an electronic social network, as described herein.

User interfaces (204) to the communication network(s) 202 can comprise various suitable devices 204, such as desktop computers, laptop computers, mobile communication devices, mobile phones, network-capable gaming devices, PDAs, and so on. Additionally, such devices 204 can comprise one or more user interface applications or systems that facilitate data exchange between a device 204 and the network(s) 202, or between devices 204. Such interface applications or systems can include e-mail, IM, SMS, operating system executables, voice-to-text or text-to-voice applications, web browser, RSS reader, RSS aggregator, or various other suitable applications or system components enabling data (e.g., text, media, voice, etc.) to be exchanged between a user device 204 and the network(s) 202.

To characterize user activity and user activity performance, system 200 can comprise activity capture components (208A, 208B, 208C) that can obtain, record or output information pertaining to human activity. The information can comprise video data processed by a video capture component 208A (e.g., a camera, video camera, web cam), audio data captured by an audio capture component 208B (e.g., microphone), tactile data processed by tactile or haptic sensors (208C), or other biometric information obtained from biometric sensors, such as infrared sensors (e.g., to measure body or surface temperature), heart rate or blood pressure sensors (e.g., to infer anxiety, emotion disposition or tension from heart rate, blood pressure or rates of changes therein), video camera (208A) to identify sweating, measure pupil dilation, and so on. Various user states, emotional dispositions or physical activities can be inferred from sensor data obtained from the various sensors 208A, 208B, 208C. In addition, users 206 can provide information pertaining to user activity (e.g., type of activity, name of activity, one or more goals, progress toward a goal, bottleneck in the progress, identity of users having experience or expertise pertinent to the activity, and so on) through manual data entry (e.g., whether text, voice or tactile based) onto one or more user devices 204. Information descriptive of user activities and states of such activities can be utilized to define user tasks against which performance of the electronic social network can be measured.

System 200 can further comprise an analysis component 210 that receives the data descriptive of user activities, as well as an analysis of an electronic social network that impacts implementation, effectiveness or efficiency of such activities. Analysis component 210 can parse and quantify/qualify received data in order to establish a performance characteristic 220 for the communication network or electronic social network. For instance, a media processor 212 can analyze audio, video, tactile, or other sensory-related media data provided by sensors 208A, 208B, 208C to identify user activities and user dispositions or emotional states with respect to such activities. Furthermore, a weighting component 214 can employ language processing to analyze communications sent by the user to other users of the communication network(s) 202. Content of such communications pertinent to identified activities can be compiled and scored based on relativity to implementation, effectiveness or efficiency of the activities. An aggregation component 216 can combine compiled scores to further characterize or assist in optimization of (e.g., see below) a state of the user with respect to the activity, or a state of the activity (e.g., started, completed, degree of progress, problems encountered in progress) itself.

In addition to the foregoing, analysis component 210 can analyze data exchanged over the communication network(s) 202 or electronic social network to determine effectiveness in implementing various user activities. Rates at which activities are initiated, progress or are completed, or rates with which data pertaining to an activity is disseminated or consumed via the network, or rates with which users communicate or collaborate can be determined by analysis component 210. The determined rates can be correlated with the user activities or states of activities, to characterize the impact of the social network or communication network(s) 202 on such activities. The characterization is output as a performance characterization file 220 for analysis by a network performance rating system, as described herein (e.g., see FIG. 1, supra).

According to at least some aspects of the subject disclosure, analysis component can employ a machine learning and optimization component 218 to optimize data analysis over time and over multiple iterations of analyzed data. For instance, accurately characterizing or identifying a task based on captured media data can be one example of optimization. Another example can comprise analyzing user communications and correlating the communications with activity-related data. Still other examples can comprise correlating user activities with network performance factors (e.g., data dissemination rates) to generate an overall characterization of an impact of an electronic social network in supporting user activities.

In order to optimize data analysis, machine learning and optimization component 218 can utilize a set of models (e.g., user interface model, text-to-speech or speech-to-text models, user biometric response model, user disposition-physical response model, language processing model, inter-user interaction model, statistical models based on the foregoing, etc.) in connection with determining or inferring user tasks and impact of the social network on such tasks. The models can be based on a plurality of information (e.g., media capture data, manual data entry, cross-network communication, etc.). Optimization routines associated with machine learning and optimization component 218 can harness a model(s) that is trained from previously collected data, a model(s) that is based on a prior model(s) that is updated with new data, via model mixture or data mixing methodology, or simply one that is trained with seed data, and thereafter tuned in real-time by training with actual field data based on parameters modified as a result of error correction instances.

In addition, machine learning and optimization component 218 can employ machine learning and reasoning techniques in connection with making determinations or inferences regarding optimization decisions, such as correlating data dissemination/consumption statistics with user activity performance, across a plurality of users and device/network use contexts of such users. For example, machine learning and optimization component 218 can employ a probabilistic-based or statistical-based approach in connection with identifying and/or updating a user disposition, physical/emotional state or activity state based on previous biometric sensor data collected for the user, or similar data collected for a plurality of similar users. Inferences can be based in part upon explicit training of classifier(s) (not shown), or implicit training based at least upon one or more monitored results, and the like.

Machine learning and optimization component 218 can also employ one of numerous methodologies for learning from data and then drawing inferences from the models so constructed (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various aspects described herein. Methodologies employed by optimization module 310 can also include mechanisms for the capture of logical relationships such as theorem provers or heuristic rule-based expert systems. Inferences derived from such learned or manually constructed models can be employed in other optimization techniques, such as linear and non-linear programming, that seek to maximize probabilities of error. For example, maximizing an overall accuracy of correlations between social network composition or capabilities and user activity performance can be achieved through such optimization techniques.

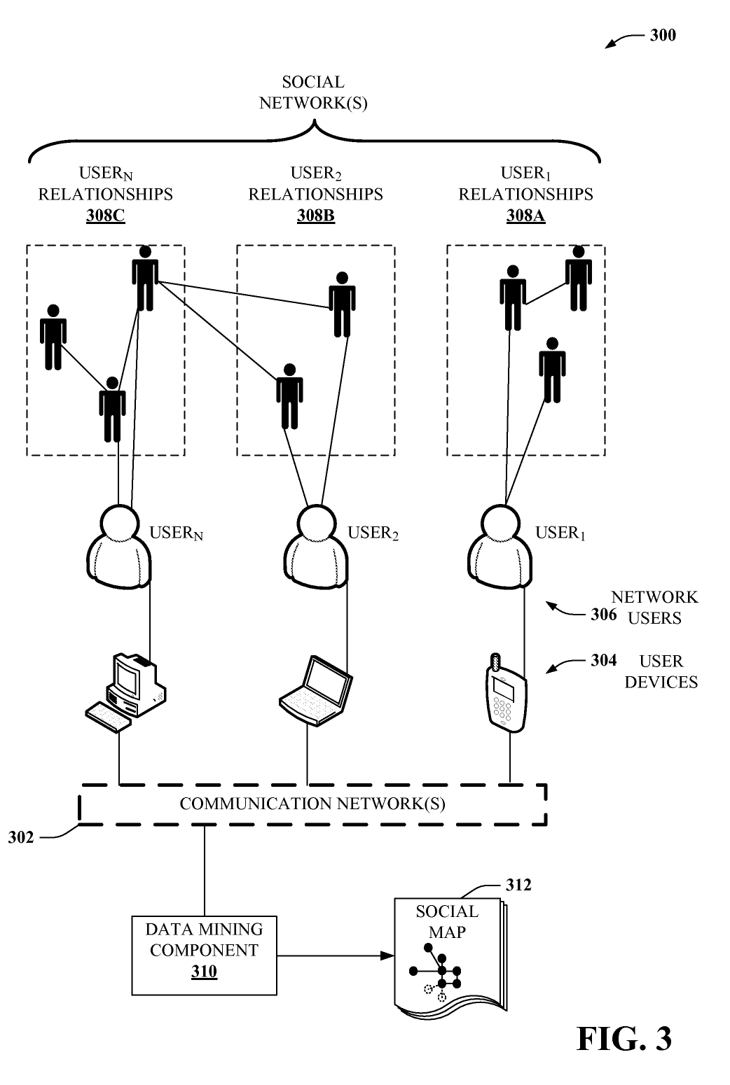

FIG. 3 depicts a block diagram of an example system 300 that can transform a human social network into an electronic representation of such network. System 300 can obtain inter-personal relationship data of a set of persons. Such data can be utilized to generate a social connectivity map 312, showing direct or indirect relationships between persons and, in some aspects, characterizing those relationships based on past, current or anticipated interactions. The social connectivity map 312 can then be programmed or stored onto communication network infrastructure components to yield an electronic social network. Such network can facilitate mass communication between users, characterization of inter-personal relationships, provide visual depiction of personal activity, aid in aggregating and maximizing human resources, and the like.

System 300 can comprise a communication network(s) 302 providing a platform for remote data exchange between one or more electronic communication devices 304. Users 306 of such devices 304 can be identified (whether single or multiple users per device, or multiple devices per user) and established as user nodes for a social network. Other persons with which the user nodes are associated with, either through direct personal interaction (e.g., direct node associations) or the personal interactions of other persons (e.g., indirect node associations), form various user relationship networks 308A, 308B, 308C, which can be integrated into the social network. Interactions between the users and their direct/indirect associates, as well as interactions among the associates themselves, whether direct or indirect, can be characterized in the social network. For instance, as depicted, user₂ has two direct relationships with two persons, but four additional indirect relationships. The indirect relationships based on a direct relationship between one such person and another person, and the direct and indirect relationships of that other person, which include user_{N} (where N is a positive integer). User1 has three direct and indirect relationships, but none that interface with person-nodes associated with user₂ or user_{N}. Thus, user1 has no direct or indirect relationship with user₂ or user_{N}, unless an interaction is established via the communication network(s) 302.

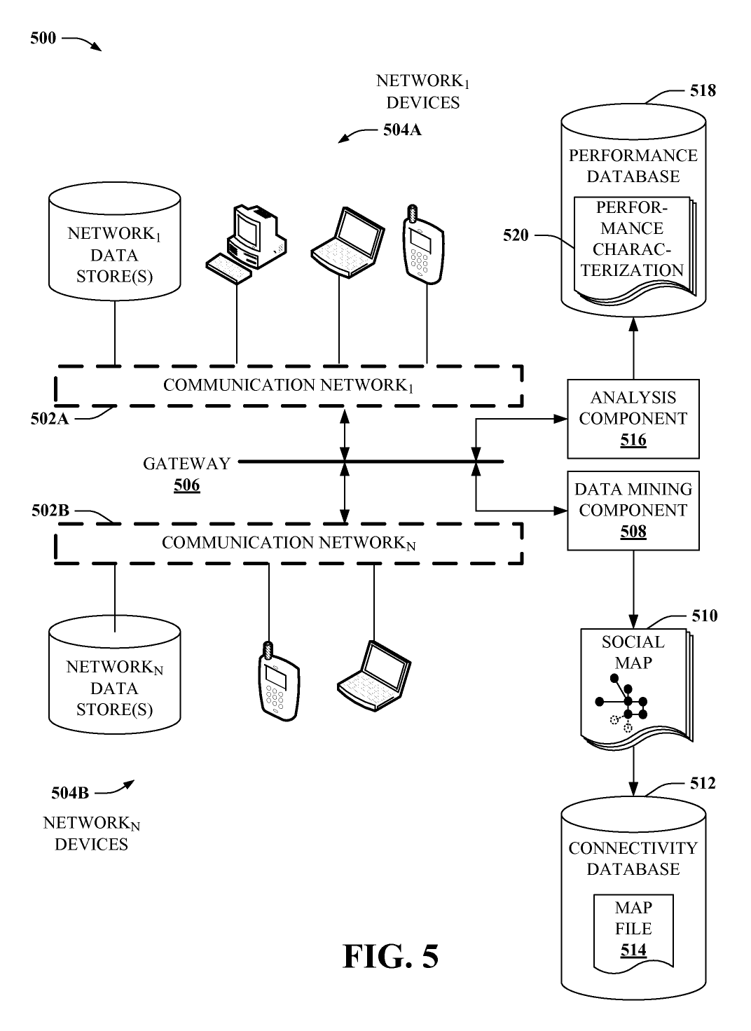

Data pertaining to personal inter-relationships can be provided by users (e.g., by uploading data to a network database—not depicted), or mined by a data mining component 310, or a combination of both. Data entry can include uploading media (e.g., pictures, video, audio, etc.) or other application files to the network(s) 302, posting text on a website or forum, transmitting or receiving an electronic message to/from or copying a person, or the like. Data mining component 310, on the other hand, can automate data compilation pertaining to users and user identity, history, background, interests, hobbies, experiences, etc. Thus, for instance, data mining component 310 can search multiple networks (e.g., see FIG. 5) for information pertaining to a set of network users, or interactions between such users or other persons (who may or may not be users of the network 302). Thus, for instance, data mining component 310 might search public social networking sites (e.g., Facebook, Twitter, LinkedIn.com, and so on) for users and user interactions, private networks maintaining private social networking applications, as well as traditional communication networks, such as e-mail servers, IM or SMS servers, mobile communication networks, etc., to find users and identify interactions, whether electronic (and, e.g., memorialized in a network component) or face-to-face (and, e.g., memorialized in communication or uploaded data). Based on the identified user nodes and interactions among such nodes, data mining component 310 can generate a social connectivity map file 312, descriptive of such user nodes and interactions. The map file 312 can be output to a network performance analysis system (e.g., see FIG. 1, supra), as described herein.

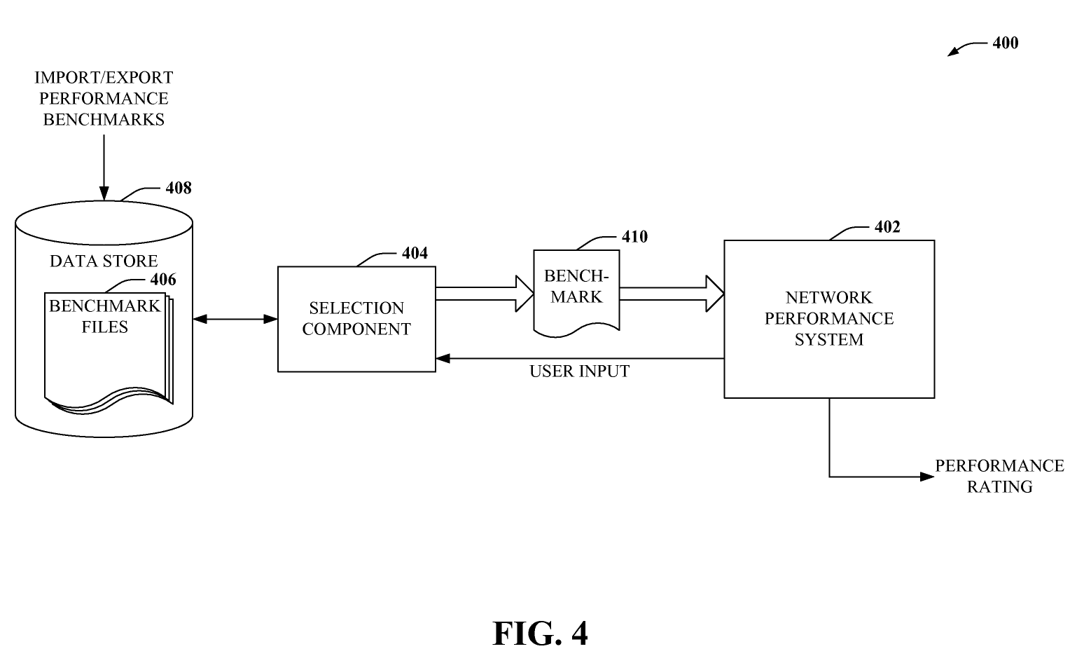

FIG. 4 depicts a block diagram of an example system 400 that can employ a set of network performance benchmarks to rate performance of an electronic social network. The performance benchmarks can comprise exportable/importable files that can be swapped in or out of a network performance system, enabling analysis of various aspects or functions of the social network, various users or user groups, various tasks or sets of tasks, or the like. In addition to the foregoing, such benchmark files can enable a social network of one organization or individual to be measured against another social network of a different organization/individual or group of organizations/individuals. Accordingly, an ecosystem of benchmarks can be provided, enabling electronic social networks to be analyzed in parts (e.g., by task(s), user(s), division(s), team(s), time period(s), etc.) or in whole, enabling trading, lease or sale of network benchmarks among various organizations, possibly resulting in additional streams of revenue for operators or purveyors of an electronic social network.

System 400 can comprise a network performance system 402 that rates performance of an electronic social network in assisting users of such network in accomplishing tasks and activities. To rate the network performance, performance system 402 can generate a correlation between dissemination/consumption of information associated with the social network and performance of the tasks/activities. A result of the correlation provides an impact of the social network on the user tasks/activities. This impact can be compared with one or more performance benchmarks to rate the performance of the social network.

According to some aspects of the subject disclosure, network performance system 402 can select among various aspects, functions, compositions, tasks, users or user groups of the social network for testing. In such aspects, a particular performance benchmark providing a standard performance for the selected network attribute can be requested by the network performance system 402. In other aspects, the network performance system 402 can select among various benchmark targets, provided by a desired benchmark organization, trained on a particular set of users (e.g., a set of expert users), trained on a particular electronic social network or type of such network, or the like. Once a desired benchmark or benchmark type is identified, network performance system sends a benchmark request to a selection component 404. Selection component 404 can reference a list of benchmark files 406 stored at a data store 408, to identify the requested benchmark, or where suitable, a most-similar benchmark file. If a suitable benchmark file is identified, selection component returns the selected benchmark file 410 to the network performance system. Based on the network characterization and selected benchmark file 410, network performance system can output a performance rating that is particular to a selected aspect or function of an electronic social network, or standardized against a desired target social network.

FIG. 5 depicts a block diagram of a sample system 500 that provides comprehensive data analysis of disparate networks to characterize and map a social network(s) for performance evaluation. System 500 can be implemented across various communication networks and electronic social networking platforms. In addition, system 500 can generate a performance characterization and social network connectivity map that can be output to a network performance system, as described herein. Accordingly, system 500 can serve as a powerful and flexible front-end for such a network performance system, enabling the performance system to be plugged-in to various networks and network infrastructures.

System 500 can comprise a plurality of communication networks, network₁ 502A through network_{N} 502B, coupled by one or more network gateways. It should be appreciated that the networks (502A, 502B) can comprise various suitable wired and wireless networks, such as the Internet, WLAN, WWAN, cellular network, WiMAX network, and so on. Additionally, the network gateway(s) 506 can comprise various suitable gateways configured to route and translate information sent between various networks, of disparate types or maintained by disparate operators.

Additionally, system 500 can comprise a set of network devices 504A, 504B coupled with the respective communication networks 502A, 502B. Such devices can include, for instance, user interface devices for enabling users to exchange data with one or more of the networks (502A, 502B) or other network devices (504A, 504B). Additionally, the network devices 504A, 504B can comprise infrastructure components, such as network servers routers, gateways, hubs, switches, databases, data stores, and the like, providing network functionality and storing and managing network applications and data.

According to particular aspects of the subject disclosure, system 500 can comprise one or more data stores (504A, 504B) that include data descriptive of inter-personal relationships of a set of users of one or more of the communication networks 502A, 502B. The descriptive data can be uploaded to the data stores by various mechanisms. Such mechanisms can include user data entry, as well as search/analysis and storage by other network components.

In addition to the foregoing, system 500 can comprise a data mining component 508 that searches, queries, snoops, etc., the user devices 504A, 504B to identify users of the communication network, and other persons associated with such users. When a user is identified, data mining component 508 can search for information pertaining to the user to identify hobbies, interests, expertise, experiences, profession, etc., associated with such user. Additionally, the data mining component 508 can attempt to identify other persons, identities of such persons, and contextual information 9 e.g., hobbies, interests, etc.), associated with such persons. Furthermore, the data mining component can search for information characterizing interactions between the user and such persons, to annotate or mark the user inter-relationships.

Data obtained by the data mining component 508 is output as a social connectivity map 510, which can be stored in a map file 514 maintained at a connectivity database 512. In some aspects of the subject disclosure, the social map 510 can characterize identified communication network users as user nodes and interactions between users and other identified persons as direct and indirect links between the user nodes. Additional contextual information pertaining to users and user node interactions can be annotated to the user nodes/interactions (e.g., as metadata, data tags, or other suitable annotation mechanism), to provide rich contextual information for the social connectivity map 510. The map 510, stored in the map file 514, can be provided to a network performance system for analysis of the composition of the inter-personal connectivity in conjunction with disseminating or consuming data pertaining to user activities and tasks, as described herein.

In addition to the foregoing, system 500 can comprise an analysis component 516 that monitors data, descriptive of user activities, generated at various user devices 504A, 504B to characterize user tasks and activities, states thereof, and dispositions of users with respect to such tasks or activities. Additionally, the analysis component 516 can monitor dissemination/consumption of data among the communication networks 502A, 502B or devices 504A, 504B as a function of user tasks/activities to characterize effectiveness of the communication networks 502A, 502B in supporting the user tasks and activities. Thus, for instance, the analysis component 516 can characterize implementation, effectiveness or efficiency of the tasks/activities as a function of the ability of social network applications to disseminate data among users, pair users or sets of users as a function of common interests, goals, tasks, etc., or facilitate consumption of data pertinent to a task/activity. The analysis component 516 can store the characterizations in a performance characterization file 520 on a performance database, for use by a network performance system as described herein.

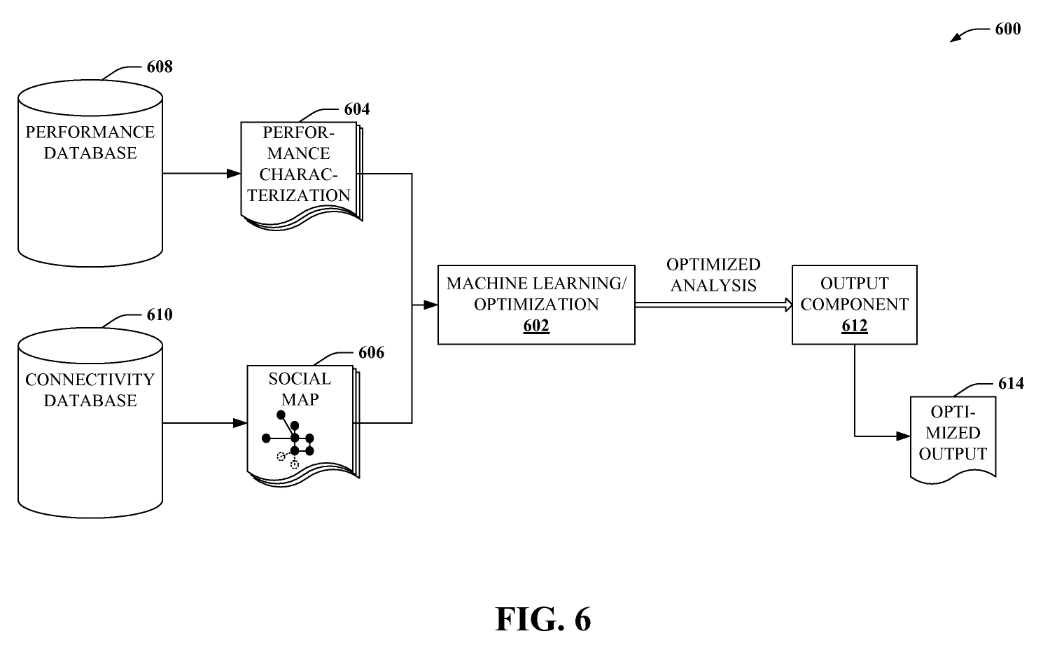

FIG. 6 depicts a block diagram of an example system 600 facilitating optimization of an electronic social network according to aspects of the subject disclosure. System 600 can identify disparities in composition of a social network, or infrastructure supporting an electronic representation of such network, and recommend changes to the composition/infrastructure to improve performance of the network.

System 600 can comprise a machine learning and optimization component 602 that obtains a performance characterization 604 of an electronic social network(s) and a social connectivity map descriptive of personal inter-relationships of a set of users of the network(s). The machine learning component 602 can analyze the performance characterization 604 to first determine effectiveness of social networking systems and applications in disseminating data throughout the network, as a baseline measure of network efficiency. Furthermore, the social connectivity map 606 can be analyzed for user node contextual information pertinent to a task or activity, distance between user nodes having pertinent information regarding a task, and the like. Thus, if a user node contains metadata indicating an expertise in a particular task, an expert association with the task can be generated for the user node.

Particular user nodes that obtain a large degree of support (e.g., in the way of communication responses, activity invitations, help requests or data supportive of an activity) from other nodes of the social network can be identified as network mavens, or influencers. Network mavens can be categorized as a function of authority within the organization, to characterize their influence based on authority, or social factors (e.g., popularity, strength of personality or character, etc.), or a combination thereof. The network mavens can be utilized as problem solving resources of the social network (e.g., analogous to users with task expertise), for implementing large user responses with relatively small effort.

In addition, bottlenecks in network efficiency can be identified by comparing the performance characterization or social connectivity map with one or more performance benchmarks suited to a desired analysis. Based on context and content of the social network, tasks or activities in progress, and a desired performance analysis, machine learning and optimization component 602 can identify changes to composition of a social network (e.g., different clustering of user nodes), based on social network resources (e.g., experts, mavens) having a likelihood of impacting performance of a task or activity. The identified changes are provided to an output component 612. Output component 612 can format the identified social network changes to an output file format sufficient for exposure to a user device. Optionally, the output file format can include a network update format sufficient to change composition of the social network according to parameters defined in an optimized output file 614. Accordingly, recommendations made by system 600 can be automatically implemented, by re-inserting the optimized output file 614 back into the electronic social network system.

The aforementioned systems have been described with respect to interaction between several components. It should be appreciated that such systems and components can include those components or sub-components specified therein, some of the specified components or sub-components, and/or additional components. For example, a system could include network performance system 102, analysis component 210, data mining component 310, selection component 404 and machine learning and optimization component 602, or a different combination of these and other components. Sub-components could also be implemented as components communicatively coupled to other components rather than included within parent components. Additionally, it should be noted that one or more components could be combined into a single component providing aggregate functionality. For instance, data mining component 508 can include analysis component 516, or vice versa, to facilitate generating a social connectivity map and a performance characterization of a social network by way of a single component. The components may also interact with one or more other components not specifically described herein but known by those of skill in the art.

Furthermore, as will be appreciated, various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, and in addition to that already described herein, can automate certain mechanisms or processes performed thereby to make portions of the systems and methods more adaptive as well as efficient and intelligent.

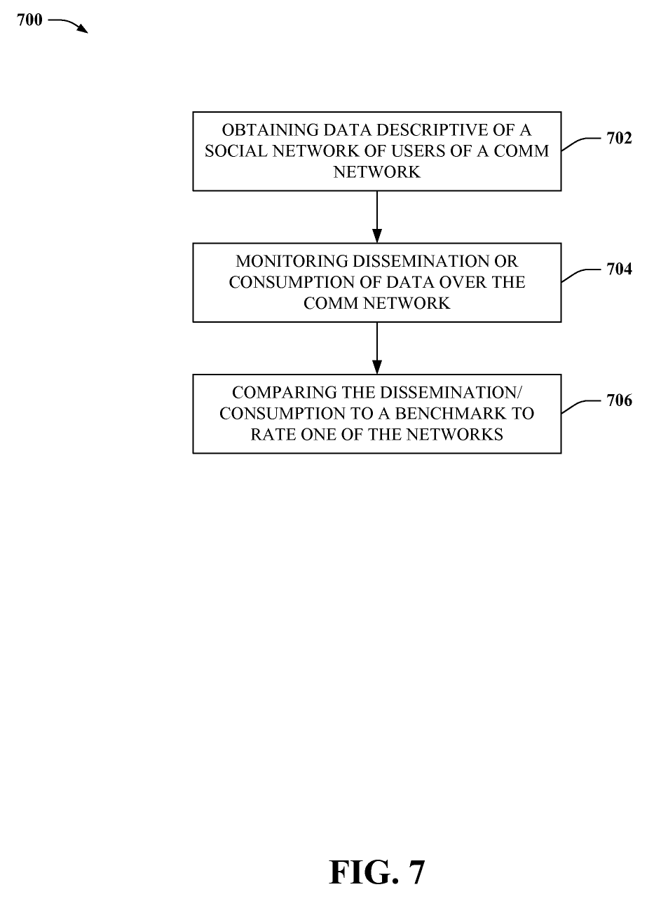

In view of the exemplary systems described supra, methodologies that may be implemented in accordance with the disclosed subject matter will be better appreciated with reference to the flow charts of FIGS. 7-9. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers. The term article of manufacture, as used, is intended to encompass a computer program accessible from any computer-readable device, device in conjunction with a carrier, or media.

FIG. 7 depicts a flowchart of an example methodology 700 for rating performance of electronic social networks according to aspects of the subject disclosure. At 702, method 700 can obtain data descriptive of inter-personal relationships of a set of users of a communication network. The inter-personal relationships can be characterized as a social network of individuals, comprising users of the communication and optionally non-users of the communication network, and indirect and direct interactions between such individuals. Additionally, the communication network can provide an infrastructure (e.g., database, query server, memory, search engine, router, etc.) for maintaining an electronic representation of the social network, and applications providing electronic communication features for users of the communication network.

At 704, method 700 can monitor dissemination or consumption of data over the communication network. The dissemination or consumption of data can be utilized to characterize effectiveness in sharing data among users of the electronic social network. Additionally, the data can be monitored to obtain or infer tasks or activities engaged in by one or more users. In some aspects, characterization can be based on ability of network applications to identify proper user nodes having expertise, experience, social influence or authority to positively impact implementation, effectiveness or efficiency of a task or activity. Alternatively, or in addition, characterization can be based on likelihood of a set of users to employ the electronic social network in solving a set of tasks. In yet other examples, characterization can be based on a degree of affinity with one or more interface applications or interface devices held by a subset of users, and ability for the applications/devices to effectively implement tasks or activities.

At 706, method 700 can compare the dissemination or consumption of data to a social network performance benchmark to rate the electronic social network or underlying communication network supporting the social network, or both. The performance benchmark can provide a standard or goal pertinent to one or more tasks, trained on a set of benchmark users, expert users, or the like. By identifying a deficiency in performing or implementing a set of tasks relative the performance benchmark, the network rating(s) can be generated and output to a user of the network for analysis.

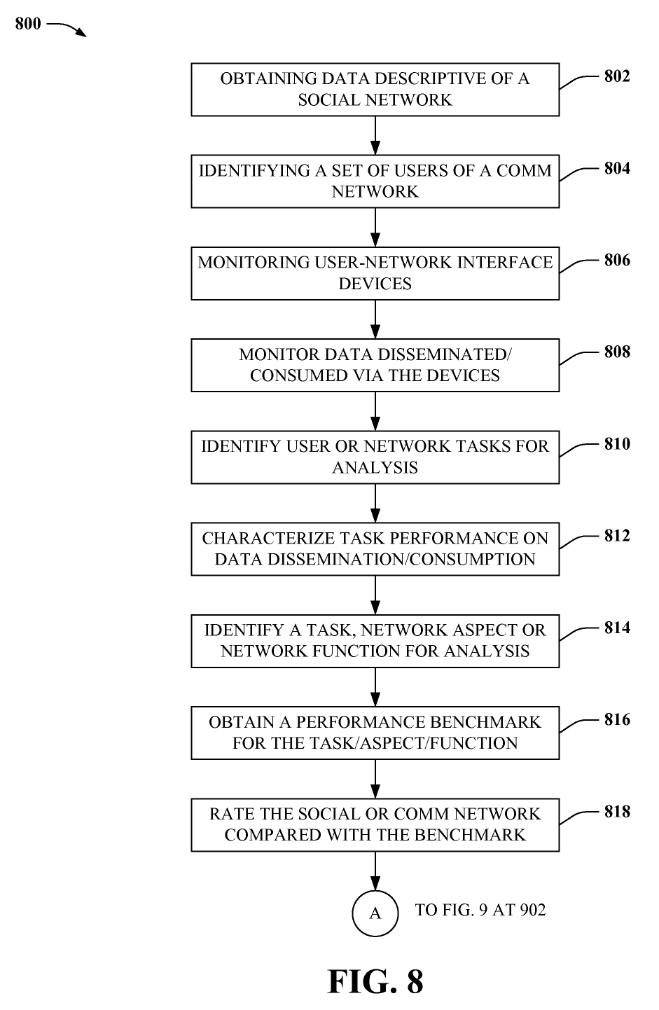

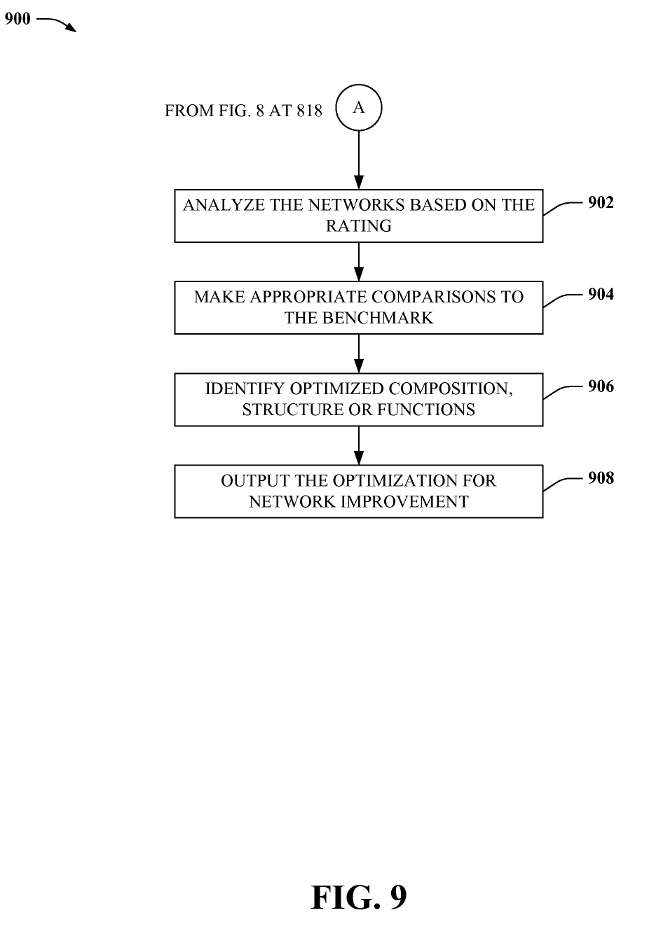

FIGS. 8 and 9 depict flowcharts of example methodologies 800, 900 for analyzing, rating or optimizing an electronic social network according to additional aspects of the subject disclosure. At 802, method 800 can obtain data descriptive of personal inter-relationships comprising a social network, as described herein. At 804, method 800 can identify a set of users of a communication network that are included in the social network. At 806, method 800 can monitor user-network interface devices to identify user-related device activities. At 808, method 800 can monitor data generated at, disseminated among or consumed by among various user-network interface devices to identify or characterize device-related tasks or communications engaged in by the set of users. At 810, method 800 can identify network or user tasks based on the monitored data. At 812, method 800 can characterize task performance based at least in part on the capability of the social network, or applications, features or functions thereof, to disseminate data or facilitate data consumption. At 814, method 800 can identify a particular task, aspect or function of the social network for analysis. At 816, method 800 can obtain a performance benchmark tuned to the particular task/aspect/function. At 818, method 800 can rate the social or communication network compared with the performance benchmark, to provide a relative measure of effectiveness in implementing the particular task, aspect or function. In some aspects, rating the social network involves rating the composition of user nodes or user node interactions utilized to associate persons based on personal interactions. According to additional aspects, rating the communication network can comprise rating social network functions and applications, such as data dissemination, data storage, analysis of user contextual information and ability to pair or recommend users based on common interests, expertise, needs, hobbies, and so on.

Referring now to FIG. 9 at 902, method 900 can continue from method 800 at 818, and analyze the networks based on the performance rating. The analysis can comprise referencing a model network composition, infrastructure, associations or features/applications utilized to train a performance benchmark. At 904, method 900 can make appropriate comparisons between the social network under test and the model network. At 906, method 900 can identify an optimized composition or structure of the social network under test based on disparity in network performances, and differences in network composition, and network features and applications. As an example, identification of data-flow bottlenecks, whether based on communication network infrastructure or social network user nodes, can be identified and recommendations for mitigating the bottleneck (e.g., by changing composition of the social network, or recommending updates to infrastructure applications or equipment) provided. At 908, method 900 can output the optimization to a user for network improvement. In at least one aspect of the subject disclosure, the output can comprise an output file configured to automatically implement changes to network composition, or software based on suitable user-node and connectivity parameters or included applications and code, respectively, written to the output file.

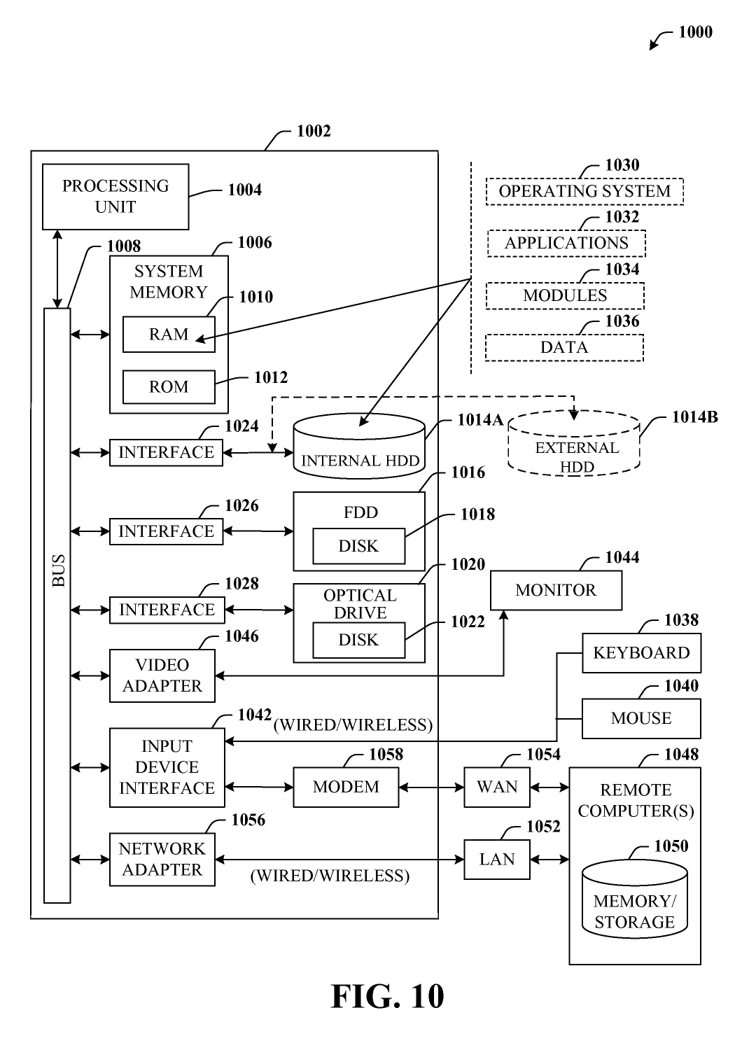

Referring now to FIG. 10, there is illustrated a block diagram of an exemplary computer system operable to execute the disclosed architecture. In order to provide additional context for various aspects of the claimed subject matter, FIG. 10 and the following discussion are intended to provide a brief, general description of a suitable computing environment 1000 in which the various aspects of the claimed subject matter can be implemented. Additionally, while the claimed subject matter described above can be suitable for application in the general context of computer-executable instructions that can run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Continuing to reference FIG. 10, the exemplary environment 1000 for implementing various aspects of the claimed subject matter includes a computer 1002, the computer 1002 including a processing unit 1004, a system memory 1006 and a system bus 1008. The system bus 1008 couples to system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014A (e.g., EIDE, SATA), which internal hard disk drive 1014A can also be configured for external use (1014B) in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing the methods of the claimed subject matter.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the claimed subject matter can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) can include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 can operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 is connected to the local network 1052 through a wired and/or wireless communication network interface or adapter 1056. The adapter 1056 can facilitate wired or wireless communication to the LAN 1052, which can also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least WiFi and Bluetooth™ wireless technologies. Thus, the communication can be a predefined structure as with a conventional network or simply an ad hoc communication between at least two devices.

WiFi, or Wireless Fidelity, allows connection to the Internet from a couch at home, a bed in a hotel room, or a conference room at work, without wires. WiFi is a wireless technology similar to that used in a cell phone that enables such devices, e.g., computers, to send and receive data indoors and out; anywhere within the range of a base station. WiFi networks use radio technologies called IEEE802.11 (a, b, g, n, etc.) to provide secure, reliable, fast wireless connectivity. A WiFi network can be used to connect computers to each other, to the Internet, and to wired networks (which use IEEE802.3 or Ethernet). WiFi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Referring now to FIG. 11, there is illustrated a schematic block diagram of an exemplary computer compilation system operable to execute the disclosed architecture. The system 1100 includes one or more client(s) 1102. The client(s) 1102 can be hardware and/or software (e.g., threads, processes, computing devices). The client(s) 1102 can house cookie(s) and/or associated contextual information by employing the claimed subject matter, for example.

The system 1100 also includes one or more server(s) 1104. The server(s) 1104 can also be hardware and/or software (e.g., threads, processes, computing devices). The servers 1104 can house threads to perform transformations by employing the claimed subject matter, for example. One possible communication between a client 1102 and a server 1104 can be in the form of a data packet adapted to be transmitted between two or more computer processes. The data packet can include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the various embodiments. It is, of course, not possible to describe every conceivable combination of components or methodologies for purposes of describing the embodiments, but one of ordinary skill in the art can recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments include a system as well as a computer-readable medium having computer-executable instructions for performing the acts and/or events of the various methods.

In addition, while a particular feature may have been disclosed with respect to only one of several implementations, such feature can be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A performance characterization system for a communication network, comprising:
a memory that obtains and stores data descriptive of a subset of inter-personal relationships of a set of users of a communication network,
a tracking component that processes data transmitted via the communication network and monitors dissemination or consumption of the data by user devices; and
a rating component that compares the dissemination or consumption against a performance benchmark to establish a performance rating for an electronic representation of a social network (electronic social network) based on the subset of inter-personal relationships.

2. The system of claim 1, further comprising an analysis component that characterizes the dissemination or consumption of the data by measuring a rate of dissemination or consumption, a task completion rate or a degree of user-interaction in conjunction with completing a task.

3. The system of claim 1, the tracking component analyzes e-mail, text message, short message service (SMS), instant message (IM), website forum, really simple syndication (RSS) or voice-to-text communication implemented via a user device to measure the dissemination or consumption of the data.

4. The system of claim 1, further comprising:
a weighting component that scores an impact of a network communication on the dissemination or consumption of the data; and
an aggregation component that compiles impact scores to facilitate characterization of the dissemination or consumption of the data.

5. The system of claim 4, the weighting component scores data relative to a top-down or viral dissemination of the data within an organization of users.

6. The system of claim 1, further comprising:
a data store that contains a plurality of performance benchmarks each pertaining to a different network of users, a type of network or a function of a network; and
a selection component that imports a selected performance benchmark from the data store to rate a type, aspect or function of the electronic social network.

7. The system of claim 1, further comprising a data mining component that obtains and analyzes Internet data stores, communication network data stores, user device data stores or user input to obtain the subset of the inter-personal relationships.

8. The system of claim 1, further comprising:
an optimization component that identifies changes to the communication network or composition of the electronic social network to improve the performance rating relative the performance benchmark; and
an output component that exposes the identified changes at one of the user devices.

9. A computer-implemented method for establishing performance of a communication network, comprising:
obtaining data descriptive of a subset of inter-personal relationships of a set of users of a communication network, the inter-personal relationships comprise a social network;
monitoring a user device providing an interface to the communication network for dissemination or consumption of user information; and
comparing the dissemination or consumption against a performance benchmark to establish a performance rating for a digital representation of the social network.

10. The method of claim 9, further comprising employing a social network benchmark or an enterprise network benchmark as the performance benchmark.

11. The method of claim 9, further comprising generating the performance benchmark based on a data dissemination rate, a task completion rate or a user interaction rate, accomplished via the communication network.

12. The method of claim 9, monitoring dissemination or consumption of information further comprises tracking data shared via e-mail, text message, short message service (SMS), instant message (IM), website forum or voice-to-text interfaces to the network.

13. The method of claim 12, further comprising scoring the dissemination or consumption of information for each message analyzed or for groups of messages related to a common set of tasks, project groups, organizations or social groups.

14. The method of claim 9, further comprising scoring data disseminated top-down from management or spread virally throughout the network.

15. The method of claim 9, further comprising storing performance ratings of a plurality of different social or enterprise networks as network benchmarks.

16. The method of claim 15, further comprising comparing the performance rating of the social network with a performance rating of at least one of the plurality of networks.

17. The method of claim 9, further comprising data mining online social network websites, private personal or business web sites, user voice communications, or electronic communications employing the communication network to identify or characterize the inter-personal relationships.

18. The method of claim 9, further comprising identifying changes in the inter-personal relationships and updating the digital representation or the performance benchmark according to the changes.

19. The method of claim 9, further comprising:
identifying a performance disparity between the performance rating and the performance benchmark;
determining a change to the composition of the communication network, the inter-personal relationships or the digital representation of the social network to improve the disparity; and
outputting the determined change to a user of the communication network.

20. A network performance characterization system, comprising:
a memory that obtains and stores data descriptive of a subset of inter-personal relationships of a set of users of a communication network, the subset of inter-personal relationships comprise a social network;
a tracking component that processes data transmitted via the communication network to monitor dissemination or consumption of the data by user devices;
an analysis component that determines a task completion rate as a function of the dissemination or consumption of the data; and
a rating component that compares the task completion rate against a performance benchmark to establish a performance rating for a digital representation of the social network.
